(19) United States
(12) Patent Application Publication
(10) Pub. No.: US 2025/0159339 A1
(43) Pub. Date: May 15, 2025

(54) OPTIMIZING EDGE-ASSISTED AUGMENTED REALITY DEVICES

(71) Applicant: NEC Laboratories America, Inc., Princeton, NJ (US)

(72) Inventors: Murugan Sankaradas, Dayton, NJ (US); Srimat Chakradhar, Manalapan, NJ (US); Ravi Kailasam Rajendran, Colonia, NJ (US); Qiang Xu, Monmouth Junction, NJ (US)

(21) Appl. No.: 18/945,989

(22) Filed: Nov. 13, 2024

Related U.S. Application Data
(60) Provisional application No. 63/548,539, filed on Nov. 14, 2023.

(51) Int. Cl. H04N 23/661; G06T 7/00; G06T 11/00

(52) U.S. Cl. CPC H04N 23/661; G06T 7/0004; G06T 11/00; G06T 2207/30164

(57) ABSTRACT

Systems and methods for optimizing edge-assisted augmented reality (AR) devices. To optimize the AR devices, frame capture timings of AR devices can be profiled that capture relationships between the AR devices. Requests from the AR devices can be analyzed to determine accuracy of the frame capture timings of the AR devices based on a service level objective (SLO) metric. A frame timing plan that minimizes overall timing changes of the AR devices can be determined by adapting the accuracy of the frame capture timings to optimal adjustments generated based on a change in device metrics for requests below an accuracy threshold. Current frame capture timings of cameras of the AR devices can be adjusted based on the frame timing plan by generating a response pocket for the AR devices.

### RELATED APPLICATION INFORMATION

This application claims priority to U.S. Provisional App. No. 63/548,539, filed on Nov. 14, 2023, incorporated herein by reference in its entirety.

### BACKGROUND

### Technical Field

The present invention relates to optimizing augmented reality device performance and more particularly to optimizing edge-assisted augmented reality devices.

### Description of the Related Art

Augmented reality (AR) superimposes a computer-generated image on a user's view of the real world. AR applications can operate on devices with limited battery capacity and can demand exceptionally low-latency performance on AR devices. Additionally, there are certain tasks that prove challenging to execute on AR devices as they cannot meet the stringent latency demands or operate without causing excessive battery drain.

### SUMMARY

According to an aspect of the present invention, a computer-implemented method is provided for optimizing edge-assisted augmented reality (AR) devices, including, profiling frame capture timings of AR devices that capture relationships between the AR devices, analyzing requests from the AR devices to determine accuracy of the frame capture timings of the AR devices based on a service level objective (SLO) metric, determining a frame timing plan that minimizes overall timing changes of the AR devices by adapting the accuracy of the frame capture timings to optimal adjustments generated based on a change in device metrics for requests below an accuracy threshold, and adjusting current frame capture timings of cameras of the AR devices based on the frame timing plan by generating a response packet for the AR devices.

According to another aspect of the present invention, a system is provided for optimizing edge-assisted augmented reality (AR) devices, including one or more AR devices, and an edge server having a memory device operatively coupled with one or more processor devices to profile frame capture timings of AR devices that capture relationships between the AR devices, analyze requests from the AR devices to determine accuracy of the frame capture timings of the AR devices based on a service level objective (SLO) metric, determine a frame timing plan that minimizes overall timing changes of the AR devices by adapting the accuracy of the frame capture timings to optimal adjustments generated based on a change in device metrics for requests below an accuracy threshold, and adjust current frame capture timings of cameras of the AR devices based on the frame timing plan by generating a response packet for the AR devices.

According to yet another aspect of the present invention, a non-transitory computer program product is provided including a computer-readable storage medium having program code for optimizing edge-assisted augmented reality (AR) devices, wherein the program code when executed on a computer causes the computer to profile frame capture timings of AR devices that capture relationships between the AR devices, analyze requests from the AR devices to determine accuracy of the frame capture timings of the AR devices based on a service level objective (SLO) metric, determine a frame timing plan that minimizes overall timing changes of the AR devices by adapting the accuracy of the frame capture timings to optimal adjustments generated based on a change in device metrics for requests below an accuracy threshold, and adjust current frame capture timings of cameras of the AR devices based on the frame timing plan by generating a response packet for the AR devices.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a flow diagram illustrating a high-level overview of a computer-implemented method for optimizing edge-enabled augmented reality (AR) devices, in accordance with an embodiment of the present invention;

FIG. 2 is a block diagram illustrating a system implementing practical applications for optimizing edge-assisted augmented reality devices, in accordance with an embodiment of the present invention;

FIG. 3 is a block diagram illustrating a system for the AR devices, in accordance with an embodiment of the present invention;

FIG. 4 is a block diagram illustrating a system for the edge server, in accordance with an embodiment of the present invention; and

FIG. 5 is a block diagram illustrating a structure of deep neural networks, in accordance with an embodiment of the present invention.

### DETAILED DESCRIPTION OF PREFERRED EMBODIMENTS

In accordance with embodiments of the present invention, systems and methods are provided for optimizing edge-assisted augmented reality (AR) devices.

In an embodiment, frame capture timings of the AR devices can be profiled that capture relationships between the AR devices. Requests from the AR devices can be analyzed to determine accuracy of the frame capture timings of the AR devices based on a service level objective (SLO) metric. A frame timing plan that minimizes overall timing changes of the AR devices can be determined by adapting the accuracy of the frame capture timings to optimal adjustments generated based on a change in device metrics for requests below an accuracy threshold. Current frame capture timings of cameras of the AR devices can be adjusted based on the frame timing plan by generating a response packet for the AR devices.

Augmented reality (AR) superimposes a computer-generated image on a user's view of the real world. It has the potential to revolutionize many industries, including healthcare, education, manufacturing, and gaming. In healthcare, AR can be used to provide surgeons with real-time information about a patient's anatomy or to help patients with rehabilitation. In education, AR can be used to create interactive learning experiences that make it easier for students to learn. In manufacturing, AR can be used to improve the efficiency of production and inspection processes and to help workers with complex tasks. In gaming, AR can be used to create immersive and interactive experiences that blur the lines between the real and virtual worlds.

Common subtasks in AR applications include object detection, depth estimation, rendering, anomaly detection, and tracking. Many of these tasks use computationally heavy deep neural network (DNN) models. Depending on the application requirements, each AR task must be executed at a certain frequency and finish within a certain latency requirement to maintain the responsiveness of the AR application. The frequency and latency requirements for each task will also vary depending on the specific application. For example, an AR application that is used for gaming may require a higher frequency and latency than an AR application that is used for education. The frequency and latency requirements can directly affect the battery life of the AR device. The development of AR applications that are both responsive and accurate is a challenging task.

Other AR task offloading methods fail to consider at least the following factors that can affect the performance of DNN serving applications:

Network connectivity between device and edge server. The quality of the network connection between the device and the edge server can have a significant impact on the performance of the application. If the network is congested or unstable, it can cause latency and jitter, which can degrade the performance of the application through the AR device.

Effect of network latency variance due to dynamic conditions. The latency of the network can vary depending on a number of factors, such as the number of users on the network, the amount of traffic on the network, and the distance between the device and the edge server. This variance can make it difficult to predict the performance of the application and the AR device.

Effect of network bandwidth availability due to multitenancy conditions. In a multi-tenant environment, the bandwidth available to each tenant can vary depending on the number of other tenants using the network. This can also affect the performance of the application through the AR device.

The present embodiments can address these challenges by enabling a network-aware batch scheduling system. The present embodiments consider the network conditions between the device and the edge server when scheduling batches of requests. By doing so, the present embodiments improve the performance of the AR devices by reducing latency and jitter of the AR application.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid-state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

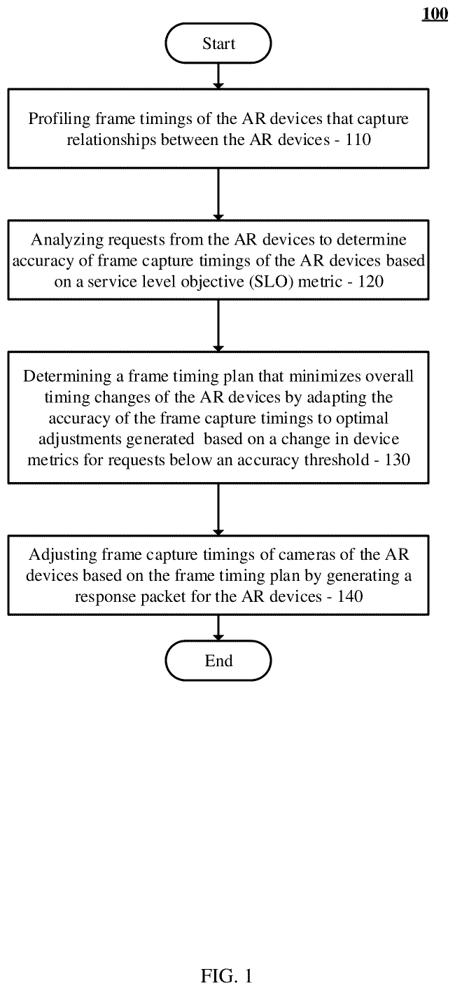

Referring now in detail to the figures in which like numerals represent the same or similar elements and initially to FIG. 1, a high-level overview of a computer-implemented method for optimizing edge-enabled AR devices is illustratively depicted in accordance with one embodiment of the present invention.

In an embodiment, frame capture timings of the AR devices can be profiled that capture relationships between the AR devices. Requests from the AR devices can be analyzed to determine accuracy of the frame capture timings of the AR devices. A frame timing plan that minimizes overall timing changes of the AR devices can be determined by adapting the accuracy of the frame capture timings to optimal adjustments generated based on a change in device metrics for requests below an accuracy threshold. Current frame capture timings of cameras of the AR devices can be adjusted based on the frame timing plan by generating a response packet for the AR devices.

Referring now to block 110 of FIG. 1 showing a method of profiling frame capture timings of the AR devices that capture relationships between the number of AR devices and target groups of AR devices, in accordance with an embodiment of the present invention.

During an offline phase, the system performance of the AR devices can be profiled by an alignment profiler based on at least two factors: number of AR devices a system can accommodate, and batch size of a chosen DNN model.

System performance profiling can be performed to capture the relationship between the number of AR devices and group size. These factors directly influence frame capture timings and subsequently, the user experience. The number of AR devices impacts the frame capture timing, which in turn affects latency. Furthermore, different group sizes necessitate distinct frame capture timing plans, as frames from AR devices within the same group are aligned, while frames from different groups are evenly distributed. A performance monitor can be utilized by the alignment profiler to collect performance metrics from the AR devices such as a request drop rate, latency, etc., by using application programming interface (API) for the AR devices.

To profile the system performance of the AR devices, the request drop rate can be assessed by the alignment profiler in an edge server. The request drop rate is a metric that gauges the efficiency of frame capture timing plans. By profiling this parameter across varying AR device counts and group sizes, the present embodiments can gain an intricate understanding of how different system configurations impact request drop rates.

This allows the present embodiments to tailor frame timing plans to achieve optimal performance for each AR device count. This iterative approach ensures that the best frame timing plans are preserved, even as the number of AR devices and group sizes change, guaranteeing consistently high-quality and low-latency AR experiences.

Specifically, the alignment profiler can profile the system performance of the AR devices with the following algorithm:
1: function FRAME TIMING PROFILER(ar_device_count,group size)
2: for ar_device size=1 to ar_device count do
3: for grp size=1 to group size do
4: total grp count=┌ar_device size/grp size┐
5: assign AR devices to target groups
6: where: requests from AR devices of same group are aligned
7: where: requests from AR devices of different groups are evenly spaced out
8: feed requests to inference engine
9: measure request drop rate & inference time
10: end for
11: CACHE best grp size for current ar_device size
12: end for
13: end function

Referring now to block 120 of FIG. 1 showing a method of analyzing requests from the AR devices to determine accuracy of the frame capture timings of the AR devices based on a service level objective (SLO) metric, in accordance with an embodiment of the present invention.

Once the offline profiling is captured, the edge server can start receiving the requests from the AR devices in real-time. As the requests are received, the edge server analyzes the request and decides if the frame capture timing can be corrected. If the requests have a Service Level Objective (SLO) metric that is below the SLO threshold, then the frame capture timing can be corrected. Otherwise, the requests would be rendered by a visual renderer. The SLO metric can include response time, latency, request drop rate, etc. The SLO threshold can be a range depending on the metric. For example, the SLO threshold can be a latency of <85 millisecond (ms), thus, the frame capture timing for a request having a latency of 86 ms can be corrected. This analysis can be performed by using a request analyzer, an inference engine, a performance monitor, and the alignment profiler.

The inference engine can learn scenarios in which the frame capture timings of the AR devices are below the SLO threshold based on metrics such as the number of AR devices and the target groups, etc. The inference engine can include a deep neural network such as TensorRT™.

Referring now to block 130 of FIG. 1 showing a method of determining a frame timing plan that minimizes overall timing changes of the AR devices to adapt the accuracy of the frame capture timings to optimal adjustments generated based on a change in device metrics for requests below an accuracy threshold, in accordance with an embodiment of the present invention.

The goal of the present embodiments is to orchestrate the frame capture timings in a way that minimizes disruptions. To achieve this goal, the present embodiments can generate a frame timing plan through an alignment planner by performing at least two steps: generation of a cost matrix, and transformation of the matrix into a linear assignment problem.

The cost matrix C can be constructed, where each cell denotes the required frame capture time change when migrating from one position to another. This matrix can encapsulate the temporal adjustments needed for a smooth transition.

The cost matrix C can then be transformed into a linear assignment problem, which can be tackled with the Hungarian algorithm. The algorithm seeks the minimum sum of costs by selecting a single element from each row, while adhering to the constraint that chosen elements must belong to distinct columns. Consequently, the cells chosen by the Hungarian algorithm can generate the optimal adjustments for the AR devices, ensuring that the transition minimizes the overall timing changes. The generation of the optimal adjustments can be learned by the inference engine and can be passed to the alignment planner.

The alignment planner can achieve smooth transitions for AR devices in frame capture timing plans, with the constraint that the overall AR frame capture timing change for all AR devices should be minimized. The alignment planner ensures that the Hungarian algorithm's selections result in the most effective and efficient adjustments, allowing AR devices to be integrated or disengaged from the frame timing plan with minimal impact on the overall system. This proactive approach to AR frame capture timing optimization enhances the quality and consistency of the user experience, particularly in dynamic scenarios involving changes in the number of AR devices.

The objective function can be formulated as follows.

$$\begin{matrix}min {\sum }_{{i ∈ G}_{j ∈ G}} {C}_{ij} {X}_{ij} subject to : {\sum }_{i ∈ U} {X}_{ij} = 1 ∀ j ∈ \\ G ; {\sum }_{j ∈ G} {X}_{ij} = 1 ∀ i ∈ U ;\end{matrix}$$

where C is the cost matrix, Xᵢⱼ∈{0, 1}∀(j∈G,i∈U) is a binary matrix, U is the number of AR devices and G is the group size for the DNN model.

At least the following steps are included in the frame capture timing alignment planning process of the alignment planner:

Initialize the cost matrix based on the required frame capture time changes for AR devices' transitions.

Apply the Hungarian algorithm to the cost matrix to identify the optimal AR device adjustments that minimize overall timing changes.

For each AR device group, batch the requests for the frame timing plans.

Optimize the batched requests to streamline resource usage.

Fine-tune the frame timing plan for each AR device, ensuring they adhere to constraints such as minimum and maximum timing change limits by utilizing the inference engine. The minimum and maximum timing change limits can be learned by the inference engine. In another embodiment, the minimum and maximum timing change limits can be a predefined number that can be computed based on the specifications of the AR devices such as latency, refresh rate, sampling rate, etc.

Then, execute the finalized frame capture timing adjustments, seamlessly transitioning the AR devices while minimizing disruptions.

Referring now to block 140 of FIG. 1 showing a method of adjusting current frame capture timings of cameras of the AR devices based on the frame timing plan by generating a response packet for the AR devices, in accordance with an embodiment of the present invention.

After generating the frame capture timing plans for the AR devices, a response builder of the edge server can generate a response packet that includes the frame capture timing plans for each AR device that can be sent to each AR device. The response packet can include packaged program code that can be received by the AR devices and can change the configuration (e.g., peripheral devices, frame capture timing, etc.) of the AR devices. The response packet can be sent through a messaging standard such as message queuing telemetry transport (MQTT), real-time transport protocol (RTP), constrained application protocol (CoAP), etc.

Once received, a response analyzer in the AR device can implement the frame capture time plans determined by the alignment analyzer in the AR device. Upon receiving the timing adjustments from the planner, the response analyzer can coordinate the camera's timing to effectuate the recommended changes. This ensures that the seamless transitions and optimal AR configuration adjustments suggested by the alignment planner are accurately executed in the device's operation. The response analyzer can utilize fine-grained control APIs for AR development platforms which can enable precise management of frame capture timing of the AR devices such HoloLens™, etc.

The response analyzer can also perform mini-step adjustment to optimize the AR devices. In this approach, when the edge server instructs an AR devices to advance or delay its requests gradually by a certain amount, for instance k ms, the response analyzer can increment or decrement the capture time of the next k frames, each by just 1 ms. This gradual adjustment strategy can contribute to smoother transitions between different time slots. Given that most frame timing changes are typically within the range of <10 ms, this technique ensures that adjustments can be accommodated within a short span of time, approximately 10 frames or 167 ms. The process of performing the frame capture timing adjustment is explained in this algorithm:
1: function RESPONSE ANALYZER
2: receive frame timing adjustment request from the frame timing planner.
3: determine the direction (advance or delay) and magnitude of the adjustment (k ms).
4: apply the incremental adjustments to the camera's frame capture timing for k consecutive frames.
5: for i=1 to k do
6: if adjusting forward
7: then delay next frame's capture time by 1 ms
8: if adjusting backward
9: then advance next frame's capture time by 1 ms
10: end for
11: notify AR device about completed incremental adjustments.
12: verify successful implementation of the adjustments by assessing AR Device's frame capture timing relative to the target time slot.
13: end function

This procedure shows how the response analyzer can manage the frame capture timing adjustments incrementally by aligning with the guidance from the alignment planner. This approach can ensure that transitions between different timing slots are executed with precision, contributing to a seamless and consistent AR experience for users.

The present embodiments can address the challenges described herein by enabling a network-aware batch scheduling system. The present embodiments consider the network conditions between the device and the edge server when scheduling batches of requests. By doing so, the present embodiments improve the performance of the AR devices by reducing latency and jitter of the AR application that can be utilized by a group of AR devices.

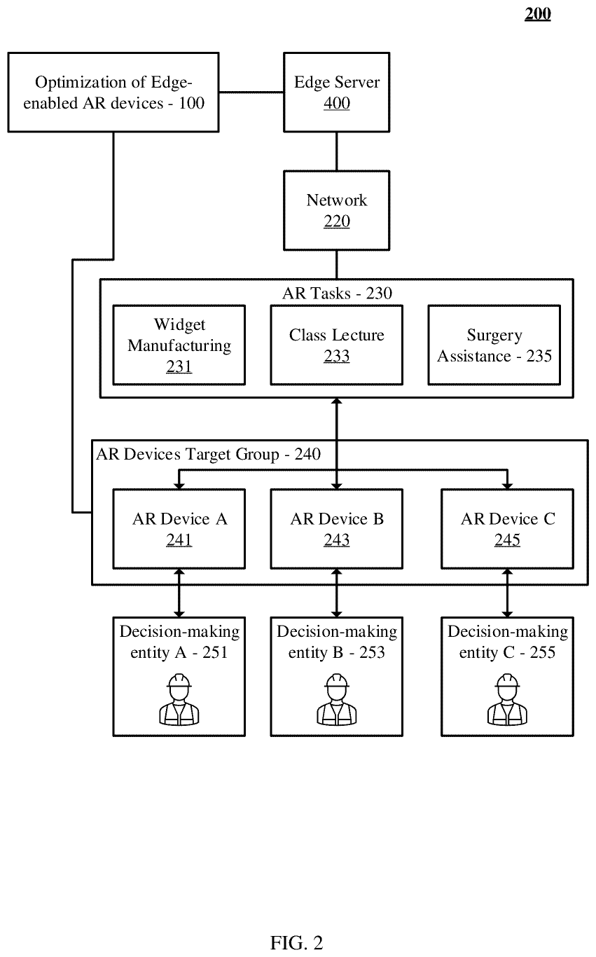

Referring now to FIG. 2, a block diagram showing a system implementing practical applications for optimizing edge-assisted augmented reality devices, in accordance with an embodiment of the present invention.

System 200 can include an edge server 400 and an AR devices target group 240 where the edge server 400 and each AR device in the AR devices target group 240 can implement optimization of edge-enabled AR devices 100. By implementing the optimization of edge-enabled AR devices 100, the AR devices target group 240 can offload requests from the AR tasks 230 to the edge server 400 which can improve the performance of the AR tasks 230 by reducing latency and jitter.

The AR tasks 230 can include widget manufacturing 231, class lecture 233, and surgery assistance 235. In widget manufacturing 231, the AR device can superimpose images into the views of the decision-making entity such as detected defects (e.g., anomaly) on the widget being manufactured, current position in the manufacturing workflow, correct/incorrect information regarding the widget (e.g., correct dimensions, examples of incorrect dimensions, etc.). For example, multiple workers e.g., decision-making entity A 251, decision-making entity B 253, decision-making entity C 255, can be part of a team of workers for widget manufacturing and each worker uses AR device A 241, AR device B 243, and AR device C 245, respectively. Decision-making entity A 251 can install part x for the widget, Decision-making entity B 253 can install part y for the widget, and decision-making entity C 255 can check the installation of part x and y for the widget. AR device A 241 can show where part x can be installed into a current stage of the widget, AR device B 243 can show where part y can be installed into the current stage of the widget, and AR device C 245 can show where both parts x and y can be installed, or a detected anomaly where part x or part y is missing. Additional decision-making entities can be added to the group while retaining the performance of the AR task for each AR device.

In another embodiment, the AR devices can show slides for a class lecture 233 which can include other information that can be detected from the text, images included in the class lecture. For example, in a class lecture 233 for the animal kingdom, pictures and information about detected animals within the lecture such as dogs can be superimposed on the views of the AR devices used by the decision-making entity A. The class lecture 233 can also include a quiz about the class lecture which can disable searching capabilities of the AR device.

In another embodiment, the AR device can be used for surgery assistance 235 which can superimpose images of body parts that are relevant to the surgery and the damage to the body part based on the surgery to the views of the AR devices. For example, during an appendectomy, the decision-making entity A 251 can use AR device A 241 which can perform surgery assistance 235. The AR device A 241 can superimpose a 3D image of the large intestine and the part where the appendix is located to the view of AR device A 241. The superimposed image can show that the appendix is enlarged and would need to be removed. The AR device A 241 can also superimpose images on the view of the AR device showing the body of the patient where incisions can be made to perform the appendectomy. Other AR tasks can be performed and the following examples are merely described for illustrative purposes.

The present embodiments can be used for other technical fields such as gaming, law, government, etc.

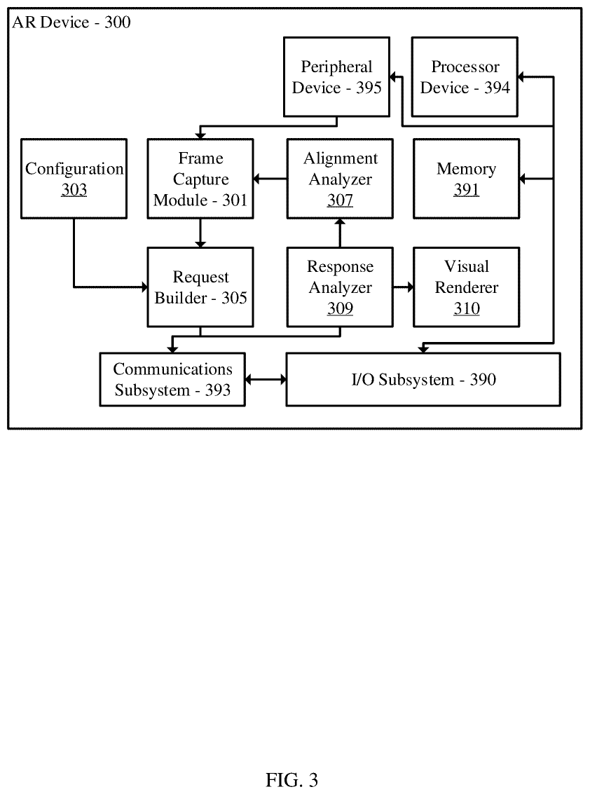

Referring now to FIG. 3, a block diagram showing a system for the AR device, in accordance with an embodiment of the present invention.

The AR device 300 illustratively includes the processor device 394, an input/output (I/O) subsystem 390, a memory 391, including a data storage device, and a communication subsystem 393, and/or other components and devices commonly found in a server or similar computing device. The AR device 300 may include other or additional components. Additionally, in some embodiments, one or more of the illustrative components may be incorporated in, or otherwise form a portion of, another component. For example, the memory 391, or portions thereof, may be incorporated in the processor device 394 in some embodiments.

The processor device 394 may be embodied as any type of processor capable of performing the functions described herein. The processor device 394 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 391 may be embodied as any type of volatile or non-volatile memory or data storage capable of performing the functions described herein. In operation, the memory 391 may store various data and software employed during operation of the AR device 300, such as operating systems, applications, programs, libraries, and drivers. The memory 391 is communicatively coupled to the processor device 394 via the I/O subsystem 390, which may be embodied as circuitry and/or components to facilitate input/output operations with the processor device 394, the memory 391, and other components of the AR device 300. For example, the I/O subsystem 390 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 390 may form a portion of a system-on-a-chip (SOC) and be incorporated, along with the processor device 394, the memory 391, and other components of the AR device 300, on a single integrated circuit chip.

The data storage device may be embodied as any type of device or devices configured for short-term or long-term storage of data such as, for example, memory devices and circuits, memory cards, hard disk drives, solid state drives, or other data storage devices. The data storage device can store program code for optimizing edge-assisted augmented reality devices 100. Any or all of these program code blocks may be included in a given computing system.

The frame capture module 301 can read the frames from the peripheral device 395 (e.g., camera) with specified frames per second at periodic intervals. The alignment analyzer 307 can analyze the frame capture timing which can be adjustable either to delay or advance the next cycle. The alignment analyzer 307 can include a lightweight deep neural network that has knowledge distilled (e.g., online distillation using outputs of the inference engine as soft targets) from the inference engine of the edge server.

The request builder 305 can take in the frame capture timings and the configuration 303 such as which task to run, service level objective (SLO), and other required information, and packages them into a request packet and forwards the request packet to the network 220 via network adapter within the communications subsystem 393. The visual renderer 310 can render the frames for the AR task based on the optimized frames.

The modules described above have program code that can be stored in the data storage device which can operatively couple with the processor device 394 to perform the actions specified in the program code for each module.

The communication subsystem 393 of the AR device 300 may be embodied as any network interface controller or other communication circuit, device, or collection thereof, capable of enabling communications between the AR device 300 and other remote devices over a network. The communication subsystem 393 may be configured to employ any one or more communication technology (e.g., wired or wireless communications) and associated protocols (e.g., Ethernet, InfiniBand®, Bluetooth®, Wi-Fi®, WiMAX, MQTT, RPT, CoAP, etc.) to affect such communication.

As shown, the AR device 300 may also include one or more peripheral devices 395. The peripheral devices 395 may include any number of additional input/output devices, interface devices, and/or other peripheral devices. For example, in some embodiments, the peripheral devices 395 may include a display, camera, touch screen, graphics circuitry, keyboard, mouse, speaker system, microphone, network interface, and/or other input/output devices, interface devices, GPS, camera, and/or other peripheral devices.

Of course, the AR device 300 may also include other elements (not shown), as readily contemplated by one of skill in the art, as well as omit certain elements. For example, various other sensors, input devices, and/or output devices can be included in AR device 300, depending upon the particular implementation of the same, as readily understood by one of ordinary skill in the art. For example, various types of wireless and/or wired input and/or output devices can be employed. Moreover, additional processors, controllers, memories, and so forth, in various configurations can also be utilized. These and other variations of the AR device 300 are readily contemplated by one of ordinary skill in the art given the teachings of the present invention provided herein.

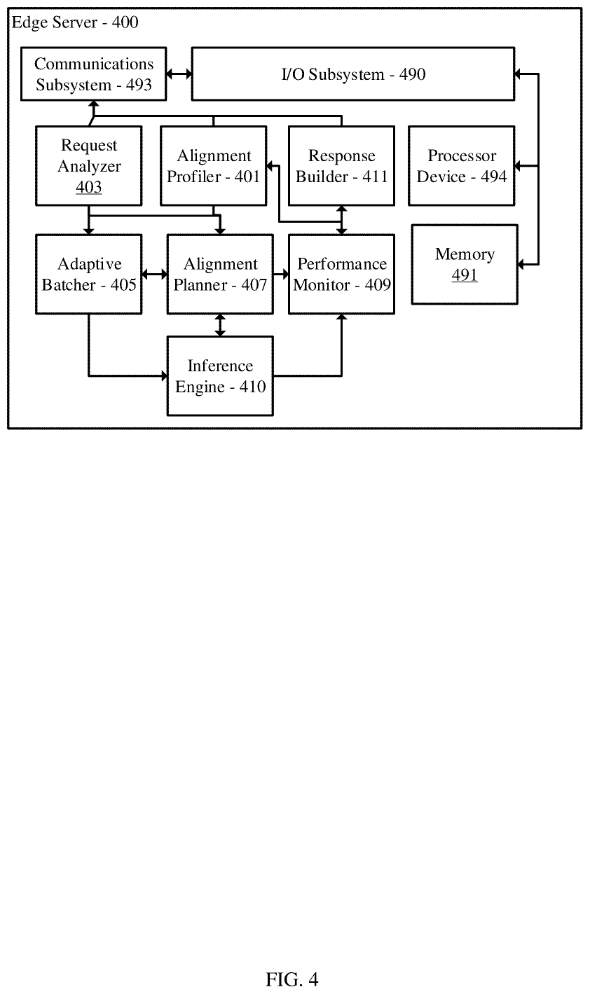

Referring now to FIG. 4, a block diagram showing a detailed view of the edge server, in accordance with an embodiment of the present invention.

The edge server 400 illustratively includes the processor device 494, an input/output (I/O) subsystem 490, a memory 491, including a data storage device, and a communication subsystem 493, and/or other components and devices commonly found in a server or similar computing device. The edge server 400 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 491, or portions thereof, may be incorporated in the processor device 494 in some embodiments.

The processor device 494 may be embodied as any type of processor capable of performing the functions described herein. The processor device 494 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 491 may be embodied as any type of volatile or non-volatile memory or data storage capable of performing the functions described herein. In operation, the memory 491 may store various data and software employed during operation of the edge server 400, such as operating systems, applications, programs, libraries, and drivers. The memory 491 is communicatively coupled to the processor device 494 via the I/O subsystem 490, which may be embodied as circuitry and/or components to facilitate input/output operations with the processor device 494, the memory 491, and other components of the edge server 400. For example, the I/O subsystem 490 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 490 may form a portion of a system-on-a-chip (SOC) and be incorporated, along with the processor device 494, the memory 491, and other components of the edge server 400, on a single integrated circuit chip.

The data storage device may be embodied as any type of device or devices configured for short-term or long-term storage of data such as, for example, memory devices and circuits, memory cards, hard disk drives, solid state drives, or other data storage devices. The data storage device can store program code for optimizing edge-assisted augmented reality devices 100. Any or all of these program code blocks may be included in a given computing system.

The request from the AR device 300 reaches the edge server 400 via the communications subsystem 493. The request analyzer 403 then analyzes the request to check if the request was sent for the first time by the AR device 300. The request analyzer 403 can also determine if the requests are below the SLO metric. If the request is from a new device, the edge server then forwards the request to both the adaptive batcher 405 as well as alignment planner 407. The alignment planner 407 runs the frame timing capture alignment for all the devices connected to edge server and figures out an optimal frame timing plan to serve all devices to guarantee low request drop rate. Once the alignment planner 407 decides the best strategy for all the devices into a frame timing plan, it sends the frame timing plan to all devices. The adaptive batcher 405 batches requests based on best batch size for the tasks and sends to inference engine 410. The results are unbatched and sent to respective devices as response by the response builder 411. The performance monitor 409 can keep records of all the request information from the devices and periodically runs statistics to see if any device is not being serviced and triggers alignment planner 407 to correct for the dropped requests, if required.

The modules described above have program code that can be stored in the data storage device which can operatively couple with the processor device 494 to perform the actions specified in the program code for each module.

The communication subsystem 493 of the edge server 400 may be embodied as any network interface controller or other communication circuit, device, or collection thereof, capable of enabling communications between the edge server 400 and other remote devices over a network. The communication subsystem 493 may be configured to employ any one or more communication technology (e.g., wired or wireless communications) and associated protocols (e.g., Ethernet, InfiniBand®, Bluetooth®, Wi-Fi®, WiMAX, MQTT, RPT, CoAP, etc.) to affect such communication.

As shown, the edge server 400 may also include one or more peripheral devices 495. The peripheral devices 495 may include any number of additional input/output devices, interface devices, and/or other peripheral devices. For example, in some embodiments, the peripheral devices 495 may include a display, touch screen, graphics circuitry, keyboard, mouse, speaker system, microphone, network interface, and/or other input/output devices, interface devices, GPS, camera, and/or other peripheral devices.

Of course, the edge server 400 may also include other elements (not shown), as readily contemplated by one of skill in the art, as well as omit certain elements. For example, various other sensors, input devices, and/or output devices can be included in edge server 400, depending upon the particular implementation of the same, as readily understood by one of ordinary skill in the art. For example, various types of wireless and/or wired input and/or output devices can be employed. Moreover, additional processors, controllers, memories, and so forth, in various configurations can also be utilized. These and other variations of the edge server 400 are readily contemplated by one of ordinary skill in the art given the teachings of the present invention provided herein.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

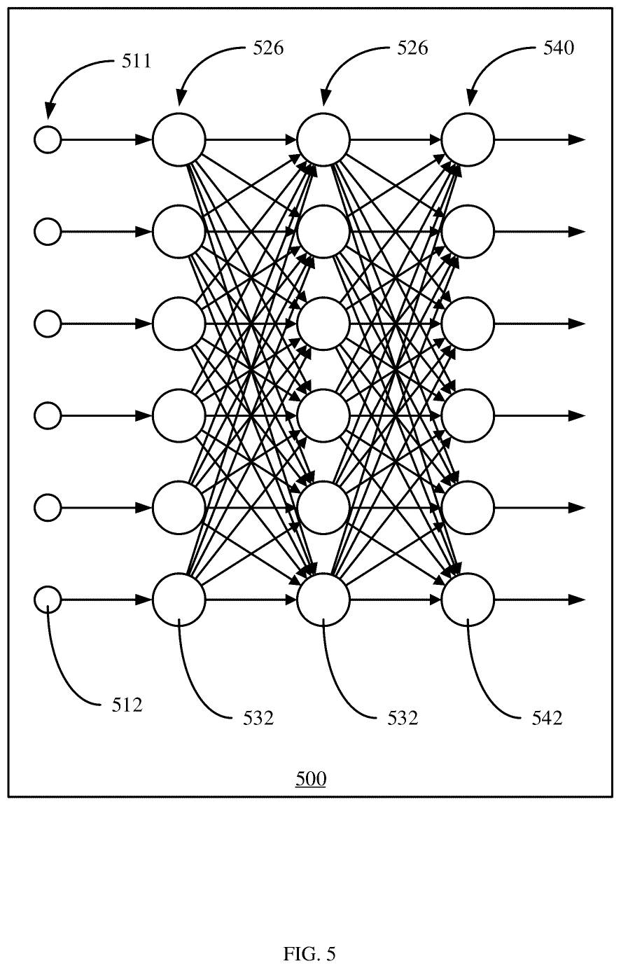

Referring now to FIG. 5, a block diagram showing a structure of deep neural networks, in accordance with an embodiment of the present invention.

A neural network is a generalized system that improves its functioning and accuracy through exposure to additional empirical data. The neural network becomes trained by exposure to the empirical data. During training, the neural network stores and adjusts a plurality of weights that are applied to the incoming empirical data. By applying the adjusted weights to the data, the data can be identified as belonging to a particular predefined class from a set of classes or a probability that the inputted data belongs to each of the classes can be output.

The empirical data, also known as training data, from a set of examples can be formatted as a string of values and fed into the input of the neural network. Each example may be associated with a known result or output. Each example can be represented as a pair, (x, y), where x represents the input data and y represents the known output. The input data may include a variety of different data types and may include multiple distinct values. The network can have one input neurons for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

The deep neural network 500, such as a multilayer perceptron, can have an input layer 511 of source neurons 512, one or more computation layer(s) 526 having one or more computation neurons 532, and an output layer 540, where there is a single output neuron 542 for each possible category into which the input example could be classified. An input layer 511 can have a number of source neurons 512 equal to the number of data values 512 in the input data 511. The computation neurons 532 in the computation layer(s) 526 can also be referred to as hidden layers, because they are between the source neurons 512 and output neuron(s) 542 and are not directly observed. Each neuron 532, 542 in a computation layer generates a linear combination of weighted values from the values output from the neurons in a previous layer, and applies a non-linear activation function that is differentiable over the range of the linear combination. The weights applied to the value from each previous neuron can be denoted, for example, by w₁, w₂, . . . wₙ₋₁, wₙ. The output layer provides the overall response of the network to the inputted data. A deep neural network can be fully connected, where each neuron in a computational layer is connected to all other neurons in the previous layer, or may have other configurations of connections between layers. If links between neurons are missing, the network is referred to as partially connected.

In an embodiment, the computation layers 526 of the inference engine 410 and the alignment analyzer can learn relationships between requests and the performance metrics. The output layer 540 of the inference engine 410 can then provide the overall response of the network as a likelihood score of the request having a metric below the SLO threshold. In another embodiment, the inference engine 410 can generate optimal adjustments based on the learned relationships.

Training a deep neural network can involve two phases, a forward phase where the weights of each neuron are fixed and the input propagates through the network, and a backwards phase where an error value is propagated backwards through the network and weight values are updated. The computation neurons 532 in the one or more computation (hidden) layer(s) 526 perform a nonlinear transformation on the input data 512 that generates a feature space. The classes or categories may be more easily separated in the feature space than in the original data space.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method for optimizing edge-assisted augmented reality (AR) devices, comprising:
profiling frame capture timings of AR devices that capture relationships between the AR devices;
analyzing requests from the AR devices to determine accuracy of the frame capture timings of the AR devices based on a service level objective (SLO) metric;
determining a frame timing plan that minimizes overall timing changes of the AR devices by adapting the accuracy of the frame capture timings to optimal adjustments generated based on a change in device metrics for requests below an accuracy threshold; and
adjusting current frame capture timings of cameras of the AR devices based on the frame timing plan by generating a response packet for the AR devices.

2. The computer-implemented method of claim 1, further comprising rendering superimposed images of a detected anomaly during a manufacturing process of a widget to the AR devices to assist a decision-making process of a decision-making entity.

3. The computer-implemented method of claim 1, wherein profiling the frame timings further comprises assessing a drop rate of the requests based on efficiency scores of offline frame timing capture plans.

4. The computer-implemented method of claim 1, wherein determining the frame timing plan further comprises transforming a generated cost matrix into a linear assignment problem to generate transition plans that minimizes overall timing changes.

5. The computer-implemented method of claim 1, wherein determining the frame timing plan further comprises generating optimal adjustments for the AR devices by seeking a minimum sum of costs by selecting a single element from each row, while adhering to a constraint that chosen elements must belong to distinct columns.

6. The computer-implemented method of claim 1, wherein determining the frame timing plan further comprises fine-tuning the frame timing plans for the AR devices based on minimum and maximum timing change limits.

7. The computer-implemented method of claim 1, wherein adjusting the current frame capture timings further comprises adjusting the current frame capture timings gradually by 1 millisecond batches.

8. A system for optimizing edge-assisted augmented reality (AR) devices, comprising:
one or more AR devices; and
an edge server including a memory device operatively coupled with one or more processor devices to:
profile frame capture timings of the AR devices that capture relationships between the AR devices;
analyze requests from the AR devices to determine accuracy of the frame capture timings of the AR devices based on a service level objective (SLO) metric;
determine a frame timing plan that minimizes overall timing changes of the AR devices by adapting the accuracy of the frame capture timings to optimal adjustments generated based on a change in device metrics for requests below an accuracy threshold; and
adjust current frame capture timings of cameras of the AR devices based on the frame timing plan by generating a response packet for the AR devices.

9. The system of claim 8, further comprising a visual renderer to render superimposed images of a detected anomaly during a manufacturing process of a widget to the AR devices to assist a decision-making process of a decision-making entity.

10. The system of claim 8, wherein to profile the frame timings further comprises to assess a drop rate of the requests based on efficiency scores of offline frame timing capture plans.

11. The system of claim 8, wherein to determine the frame timing plan further comprises transforming a generated cost matrix into a linear assignment problem to generate transition plans that minimizes overall timing changes.

12. The system of claim 8, wherein to determine the frame timing plan further comprises generating optimal adjustments for the AR devices by seeking a minimum sum of costs by selecting a single element from each row, while adhering to a constraint that chosen elements must belong to distinct columns.

13. The system of claim 8, wherein to determine the frame timing plan further comprises fine-tuning the frame timing plans for the AR devices based on minimum and maximum timing change limits.

14. The system of claim 8, wherein to adjust the current frame capture timings further comprises adjusting the current frame capture timings gradually by 1 millisecond batches.

15. A non-transitory computer program product comprising a computer-readable storage medium including program code for optimizing edge-assisted augmented reality (AR) devices, wherein the program code when executed on a computer causes the computer to:
profile frame capture timings of AR devices that capture relationships between the AR devices;
analyze requests from the AR devices to determine accuracy of the frame capture timings of the AR devices based on a service level objective (SLO) metric;
determine a frame timing plan that minimizes overall timing changes of the AR devices by adapting the accuracy of the frame capture timings to optimal adjustments generated based on a change in device metrics for requests below an accuracy threshold; and
adjust current frame capture timings of cameras of the AR devices based on the frame timing plan by generating a response packet for the AR devices.

16. The non-transitory computer program product of claim 15, further comprising to render superimposed images of a detected anomaly during a manufacturing process of a widget to the AR devices to assist a decision-making process of a decision-making entity.

17. The non-transitory computer program product of claim 15, wherein to profile the frame timings further comprises to assess a drop rate of the requests based on efficiency scores of offline frame timing capture plans.

18. The non-transitory computer program product of claim 15, wherein to determine the frame timing plan further comprises transforming a generated cost matrix into a linear assignment problem to generate transition plans that minimizes overall timing changes.

19. The non-transitory computer program product of claim 15, wherein to determine the frame timing plan further comprises generating optimal adjustments for the AR devices by seeking a minimum sum of costs by selecting a single element from each row, while adhering to a constraint that chosen elements must belong to distinct columns.

20. The non-transitory computer program product of claim 15, wherein to determine the frame timing plan further comprises fine-tuning the frame timing plans for the AR devices based on minimum and maximum timing change limits.
